(19) United States
(12) Patent Application Publication
(10) Pub. No.: US 2021/0142002 A1
(43) Pub. Date: May 13, 2021

(54) GENERATION OF SLIDE FOR PRESENTATION

(71) Applicant: Microsoft Technology Licensing, LLC, Redmond, WA (US)

(72) Inventors: Lei Cui, Beijing (CN); Shaohan HUANG, Redmond, WA (US); Xingxing ZHANG, Redmond, WA (US); Furu WEI, Redmond, WA (US); Ming ZHOU, Beijing (CN)

(21) Appl. No.: 17/052,102

(22) PCT Filed: Jun. 18, 2019
(86) PCT No.: PCT/US2019/037562

§ 371 Date: Oct. 30, 2020

(30) Foreign Application Priority Data
Jun. 25, 2018 (CN) 201810664753.0

(51) Int. Cl. G06F 40/186; G06T 11/60; G06F 3/0481; G06F 40/106; G06F 40/174; G06F 40/253; G06F 3/0482; G06F 40/30; G06N 3/08

(52) U.S. Cl. CPC G06F 40/186; G06T 11/60; G06F 3/04817; G06F 40/106; G06T 2200/24; G06F 40/253; G06F 3/0482; G06F 40/30; G06N 3/08; G06F 40/174

(57) ABSTRACT

In embodiments of the present disclosure, there is provided a method of generating a slide for presentation. Upon a target passage for presentation is obtained, a plurality of sentences are generated based on the target passage, and a label associated with each sentence and an icon corresponding to each label are determined. Then, the sentences, labels and icons are displayed in association in a user interface of an application for presentation. According to embodiments of the present disclosure, the illustrated slides can be automatically generated for a passage to be presented, which can improve efficiency of slide making and improve user experience for slide presentation.

### BACKGROUND

A presentation application is an application program used for presenting documents. The presentation application may be used to express ideas in front of many people so as to improve communication efficiency, and it is extensively applied in school teaching, various conferences, product presentations and the like. For any people who needs to present information to the crowd, the presentation application is an important software application. The presentation program can generate a series of slides, and the slide is a user interface containing texts, numbers, graphics (e.g., charts, clip art or pictures) or any combinations thereof and may have a variety of background images.

The text in the presentation application usually is the natural language intelligible to humans. The processing of the natural language refers to providing a computer with human-like text processing capability to realize natural language communications between humans and machines, which means that the computer can understand the meaning of the natural language text and express given intention and idea with the natural language text. The former is known as natural language understanding while the latter is referred to as natural language generation. Natural language processing is widely applied into search engine, machine translation, voice recognition and chatting robots and the like.

### SUMMARY

In embodiments of the present disclosure, there is provided a method of generating a slide for presentation. Upon a target passage for presentation is obtained, a plurality of sentences are generated based on the target passage, and a label associated with each sentence and an icon corresponding to each label are determined. Then, the sentences, labels and icons are displayed in association in a user interface of an application for presentation. According to embodiments of the present disclosure, the illustrated slides can be automatically generated for a passage to be presented, which not only can improve efficiency of slide making but also can improve user experience for slide presentation.

This Summary is provided to introduce a selection of concepts in a simplified form that are further described below in the Detailed Description. This Summary is not intended to identify key features or essential features of the claimed subject matter, nor is it intended to be used to limit the scope of the claimed subject matter.

### BRIEF DESCRIPTION OF THE DRAWINGS

With reference to the drawings and the following detailed description, the above and other features, and advantages of the embodiments of the present disclosure will become more apparent. In the drawings, same or similar reference signs usually refer to same or similar elements, wherein:

FIG. 1 illustrates a block diagram of a computing device/server in which one or more embodiments of the present disclosure may be implemented;

FIG. 2 illustrates a flowchart of a method for generating a slide for presentation in accordance with embodiments of the present disclosure;

FIGS. 3A-3C illustrate diagrams of a Graphical User Interfaces (GUIs) of a process for generating a slide for presentation in accordance with embodiments of the present disclosure;

FIG. 4 illustrates a flowchart of a process of generating a plurality of sentences based on a target passage in accordance with embodiments of the present disclosure;

FIG. 5 illustrates a schematic diagram for training a sentence ranking model in accordance with embodiments of the present disclosure;

FIG. 6 illustrates a schematic diagram of a sequence-to-sequence framework for converting sentences in accordance with embodiments of the present disclosure;

FIG. 7 illustrates a flowchart of a process for determining a label associated with the sentence in accordance with embodiments of the present disclosure; and

FIG. 8 illustrates a schematic diagram of a neural network semantic matching model in accordance with embodiments of the present disclosure.

### DETAILED DESCRIPTION

The embodiments of the present disclosure will be described in more details below with reference to the drawings. Although the drawings illustrate some embodiments of the present disclosure, it should be appreciated that the present disclosure can be implemented in various manners and should not be limited to the embodiments explained herein. On the contrary, the embodiments are provided to more thoroughly and completely understand the present disclosure. It should be understood that the drawings and the embodiments of the present disclosure are only for the purpose of examples and are not intended to restrict the protection scope of the present disclosure.

As used herein, the term “includes” and its variants are to be read as open-ended terms that mean “includes, but is not limited to.” The term “based on” is to be read as “based at least in part on.” The term “one embodiment” is to be read as “at least one embodiment.” The term “a further embodiment” is to be read as “at least a further embodiment.” The term “some embodiments” represents “at least some embodiments.” Related definitions of other terms will be provided in the following description.

Traditionally, when a user wants to make a slide using a passage, it is usually required to analyze the text content manually and pick a suitable part to place in presentation application. Then, the slide is composed manually. In case where an illustrating picture is required, the user also needs to open up a picture library or a search engine to look for associated picture and insert it into the presentation application. Accordingly, the traditional method for making slides is inefficient and the user experience of the made slides is also unsatisfactory.

Therefore, embodiments of the present disclosure provide a method, device and computer program product for automatically generating a slide(s) for presentation. In embodiments of the present disclosure, the illustrated slides are generated automatically through natural language processing and semantic matching, for a passage to be presented, which not only can improve the efficiency of slide making and but also improve the user experience during slide presentation.

Basic principles and several example implementations of the present disclosure are explained below with reference to FIGS. 1 to 8. FIG. 1 illustrates a block diagram of a computing device/server 100 where one or more embodiments of the present disclosure may be implemented. It should be understood that the computing device/server 100 as shown in FIG. 1 is only exemplary and should not constitute any restrictions over functions and scopes of the embodiments described herein.

According to FIG. 1, the computing device/server 100 is in the form of a general purpose computing device. Components of the computing device/server 100 may include, but not limited to, one or more processors or processing units 110, memory 120, storage device 130, one or more communication units 140, one or more input devices 150 and one or more output devices 160. The processing unit 110 can be a physical or virtual processor and can execute various processing based on the programs stored in the memory 120. In a multi-processor system, a plurality of processing units may execute computer-executable instructions in parallel to enhance parallel processing capability of the computing device/server 100.

The computing device/server 100 generally includes a plurality of computer storage media. Such media can be any attainable media accessible by the computing device/server 100, including but not limited to volatile and non-volatile media, removable and non-removable media. The memory 120 may be a volatile memory (e.g., register, cache, Random Access Memory (RAM)), a non-volatile memory (such as, Read-Only Memory (ROM), Electrically Erasable Programmable Read-Only Memory (EEPROM), flash), or any combinations thereof. The storage device 130 may be removable or non-removable medium, and may include machine readable medium, such as flash drive, disk, or any other media, which can be used for storing information and/or data (e.g., training data for training) and may be accessed within the computing device/server 100.

The computing device/server 100 may further include a removable/non-removable, volatile/non-volatile storage medium. Although not shown in FIG. 1, there may be provided a disk drive for reading from or writing into a removable and non-volatile disk (such as floppy disk) and an optical disk drive for reading from or writing into a removable and non-volatile optical disk. In such cases, each drive can be connected via one or more data medium interfaces to the bus (not shown). The memory 120 may include a computer program product 125 having one or more program modules, which are configured to execute the method or actions of various embodiments of the present disclosure.

The communication unit 140 implements communication with another computing device through communication media. Additionally, functions of components of the computing device 100 can be realized by a single computing cluster or a plurality of computing machines, and these computing machines can communicate through communication connections. Therefore, the computing device/server 100 can be operated in a networked environment using a logic connection to one or more other servers, a network Personal Computer (PC) or a further network node.

The input device 150 may be one or more various input devices, such as mouse, keyboard, trackball and the like. The output device 160 may be one or more output devices, such as display, loudspeaker and printer etc. The computing device/server 100 also can communicate through the communication unit 140 with one or more external devices (not shown) as required, wherein the external device, such as storage device, display device and the like, communicates with one or more devices that enable the users to interact with the computing device/server 100, or with any device (such as network card, modem and the like) that enables the computing device/server 100 to communicate with one or more other computing devices. Such communication can be executed via Input/Output (I/O) interface (not shown).

As shown in FIG. 1, the computing device/server 100 can input a target passage 310 (which can be one or more paragraphs of text contents) via the input device 150, and then process the input target passage 310 using the program product 125 and output an illustrated slide 360 for presentation via the output device 160.

Those skilled in the art should understand that although FIG. 1 illustrates receiving an input passage via the input unit 150 and outputting a slide via the output unit 160, the communication unit 140 may be used for receiving input and sending output directly. Example embodiments of how the program product 125 generates a slide based on the target passage will be described in details with reference to FIGS. 2-8.

FIG. 2 illustrates a flowchart of a method 200 for generating a slide for presentation in accordance with embodiments of the present disclosure. It should be understood that the method 200 may be executed by the computing device/server 100 as described with reference to FIG. 1. In order to clearly set forth the method 200 of FIG. 2, examples of Graphical User Interfaces (GUIs) of FIGS. 3A-3C are described together, wherein FIGS. 3A-3C illustrate GUI diagrams of a process for generating a slide for presentation in accordance with embodiments of the present disclosure.

At 202, a plurality of sentences are generated based on a target passage. For example, the target passage has one or more paragraphs of text contents to be presented by the user and may include a plurality of sentences. In some embodiments, the target passage may be split into sentences, and a plurality of sentences with important semantics may be selected on the basis of text hierarchy. Example implementations of generating a plurality of sentences are further described below with reference to FIGS. 4-5.

For example, FIG. 3A illustrates a diagram 300 of generating a plurality of sentences 320 based on a target passage 310. According to FIG. 3A, the target passage 310 includes four sentences which introduce sports themes, respectively “Hockey, skiing, and mountaineering, are the primary fitness drivers for Swiss Citizens,” “One of the most powerful economies in the world is driven by companies like A and B companies,” “Tourism is driven by the ski industry as well as hiking and mountaineering” and “Hiking and mountaineering are vigorous actives requires a person to constantly be on their feet in various different terrains.” It is determined that the first three sentences are relative important through semantic analysis of the target passage 310. Therefore, only the first three sentences are extracted and the last sentence is ignored. In some embodiments, the user may set the number of sentences displayed in the slide. It should be appreciated that although the embodiments of the present disclosure take English as an example for generating the slide, Chinese, Japanese and other languages are also feasible. Embodiments of the present disclosure are not restricted by the language of the target passage.

In some embodiments, after selecting a plurality of sentences from the target passage, the sentences also may be compressed for a more concise presentation in the presentation application. For example, sentences can be converted, for example, long sentences are converted into short sentences. An example implementation of sequence-to-sequence framework for converting sentences is described below with reference to FIG. 6. In addition, to adapt to the presentation of the slide, a headline of the slide also may be generated automatically based on the contents of the target passage. For example, the theme of the target passage may be determined, and the theme may be regarded as the headline of the slide.

Continue to refer to FIG. 2. At 204, labels associated with sentences in the plurality of sentences are determined. For example, the label suitable for each sentence may be determined using a neural network semantic matching model, wherein the label may include one or more words. An example implementation for determining a label with a neural network semantic matching model will be described below with reference to FIGS. 7-8.

At 206, icons corresponding to labels are obtained. The icon refers to a graphic with a reference meaning. In the slide presentation, the use of an appropriate icon can enhance display effects and improve user experience. In some embodiments, to ensure uniformity of the slides, corresponding icons may be obtained from the icon library, wherein the icon library has one or more pre-collected icon sets, each has a similar style. In some embodiments, each icon has a corresponding keyword, and the icon may be selected by matching the label with the keyword of the icon.

For example, FIG. 3B illustrates a diagram 330 of determining a plurality of labels 340 and a plurality of associated icons 350 based on the plurality of sentences 320. As illustrated by FIG. 3B, it can be determined that the content of the sentence 321 “Hockey, skiing, and mountaineering, are the primary fitness drivers for Swiss Citizens” is associated with fitness, and the associated label 341 is accordingly determined as “Fitness.” Then, a skiing icon 351 corresponding to the label 341 is obtained. Similarly, labels 342 and 343 and icons 352 and 353 are respectively obtained for the sentences 322 and 323.

Continue to refer to FIG. 2, the sentences, labels and icons are displayed in association in a user interface of the presentation application. For example, FIG. 3C illustrates a slide 360 for presentation, where each sentence and its associated label and icon are displayed together. According to FIG. 3C, sentence 321, label 341 and icon 351 are aggregated and displayed at the left side of the slide 360; sentence 322, label 342 and icon 352 are aggregated and displayed at the middle of the slide 360; and sentence 323, label 343 and icon 353 are aggregated and displayed at the right side of the slide 360. Therefore, the method 200 in accordance with embodiments of the present disclosure can automatically generate an illustrated slide for the target passage, which can improve the efficiency of slide making and improve user experience during slide presentation.

In some embodiments, a template of the slide may be determined, and the sentence and its label and icon are filled into the corresponding parts of the template. Optionally, the template may be selected or set by the user in advance. Alternatively, the template also may be automatically selected based on the number of split sentences. In some embodiments, the template may be automatically selected based on a style of the user's personal profile and/or an organization to which the user belongs. The template not only can be a plate-type, but also can include font, size and color of the text. In this way, the contents generated in accordance with the target passage can be displayed in the user interface regularly, thereby enhancing presentation effects of the slide.

In some embodiments, a theme associated with the target passage may be determined and an image associated with the theme may be obtained, and the image is filled into the template as a background image of the user interface. In this way, the background image suitable for the target passage may be obtained automatically. It should be understood that the background image may be obtained from a pre-set picture library, or from a search engine in real time via the network. Moreover, the display of the background image generally should not affect the display of the icon, so as to avoid causing display confusion between the image and the icon.

FIG. 4 illustrates a flowchart of a process 400 of generating a plurality of sentences based on the target passage in accordance with embodiments of the present disclosure. It should be understood that the process 400 may be executed by the computing device/server 100 as described with reference to FIG. 1 and the process 400 may be an exemplary specific implementation of the action 202 as described above with reference to FIG. 2.

At 402, the target passage is split into a set of sentences. For example, the sentence may be split following a common splitting manner in the linguistics, such as splitting by using full stop, question mark, exclamation mark and the like as separators. At 404, the sentences in the set of sentences are ranked. For example, the plurality of sentences may be ranked in terms of semantic importance using a trained sentence ranking model.

FIG. 5 illustrates a schematic diagram 500 for training a sentence ranking model in accordance with embodiments of the present disclosure. As shown in FIG. 5, the sentence ranking model is trained using a dataset 510, and the dataset 510 includes a plurality of documents 513 and corresponding manually annotated abstracts 516. Each document in the documents 513 is split into a plurality of sentences 520, such as S₁, S₂ . . . Sₙ. Next, a scoring model 530 generates scores 540 corresponding to the plurality of sentences based on the plurality of sentences 520 and corresponding manually annotated abstracts 513. For example, if one sentence has a high similarity with the abstract or a given sentence in the abstract, the sentence may be given a higher score, vice versa.

Continue to refer to FIG. 5, a feature extractor 550 may extract set of features of each sentences in the plurality of sentences 520. In some embodiments, the set of features may include structural features and content features of the sentence, wherein the structural features may include position and length of the sentence and the content features may comprise a frequency of a word in the sentence, a degree of overlapping between the sentence and the theme of the target passage, and a ratio of stop words in the sentence. Next, a sentence ranking model 560 is trained based on the set of features extracted by the feature extractor 550 and the scores 540, so as to generate the trained sentence ranking model 560. After training the sentence ranking model 560, the set of features of each sentence may be extracted for a plurality of sentences to be ranked, and then the sentence ranking model 560 calculates the score of each sentence based on the set of features, so as to rank the plurality of sentences.

Continue to refer to FIG. 4, at 406, a subset of sentences are selected from the set of sentences based on ranking. For example, a predetermined number of sentences, which rank in the top, may be selected as the subset of sentences. In some embodiments, semantic deduplication also can be performed on the sentences during the selection of the plurality of sentences. At 408, the order of the sentences in the subset of sentences is adjusted to obtain a plurality of sentences. In other words, after the subset of sentences is obtained according to sentence importance, the subset of sentences is adjusted based on the original ranking of these sentences therein so as to satisfy the requirements for presentation and display. In this way, a plurality of sentences with important semantics can be obtained from the target passage for presentation.

After the plurality of sentences with important semantics are obtained, the sentences may be compressed to generate shorter and simpler short sentences. In some embodiments, during the procedure of converting long sentences into short sentences, a plurality of candidate short sentences may be generated for each long sentence, and the plurality of candidate short sentences are displayed at one side of the user interface of the presentation application. Afterwards, a corresponding short sentence is determined based on user selection for a certain short sentence. Accordingly, the user is allowed to select the most suitable short sentence, thereby improving the user experience.

In some embodiments, a sentence conversion model may be trained using a pair of long and short sentences, where the pair of long and short sentences may include training samples having long sentences and associated short sentences, and then the long sentences are converted into short sentences using the trained sentence conversion model. In some embodiments, a corpus of pairs of long and short sentences for training may be built. For example, the pair of long and short sentences may include abstract and headline of the paper, focus and associated sentences of a story in the web news, first sentence of the web news and headline of the news and so on.

In some embodiments, long sentences may be converted into short sentences using the sequence-to-sequence (seq2seq) framework. FIG. 6 illustrates a schematic diagram of a sequence-to-sequence framework 600 for converting sentences in accordance with embodiments of the present disclosure, where two recurrent neural networks (RNN) are included, such as encoder RNN 610 and decoder RNN 620. During encoding, a word vector is input sequentially to a network using memory function of the RNN and through sequence relation of the context, and a weighted sum of all word vectors, as one result, is finally outputted for use by the decoder. During decoding, it is firstly required that one identifier represents start of a sentence, and then the identifier is input to the network to obtain a first output as the first word of the sentence. Next, the first word serves as a next input of the network and the resulted output acts as a second word. The cycle continues until a final sentence outputted from the network is obtained. In the sequence-to-sequence framework 600, the encoder can be a bidirectional Gated Recurrent Unit (GRU) or a bidirectional Long Short Term Memory (LSTM) network, which can encode the input sentences. The decoder, upon decoding, may be a GRU or LSTM.

In some embodiments, when the conversion between long and short sentences is executed using the sequence-to-sequence framework (for example, generative abstract), the semantic importance of each word in the long sentence may be determined. Important words are extracted, based on the semantic importance, from the long sentence, and then the short sentence is generated using the extracted important words. For instance, in the example of FIG. 6, for the long sentence “the sri lankan government on Wednesday announced the closure of government schools with immediate effect as a military against tamil separatists escalated in the north of the country,” the important words may be determined, by a selective gate network, as “sri lankan,” “closure,” “government schools,” “immediate effect,” “military” and “tamil separatists escalated.” Then, the important words are used to generate a corresponding short sentence “sri Lankan closes schools as war escalates.” It can be observed that the generated short sentence is shorter and simpler than the original long sentence and is particularly suitable for the requirement of slide presentation. In this way, as a selective gate network is used at the encoding end, important words can be predetermined so as to improve efficiency and accuracy of sentence conversion.

FIG. 7 illustrates a flowchart of a process 700 for determining a label associated with the sentence in accordance with embodiments of the present disclosure. It should be understood that the process 700 may be executed by the computing device/server 100 as described with reference to FIG. 1 and the process 700 also may be an exemplary specific implementation of the action 204 as described above with reference to FIG. 2.

At 702, a text and a subject word associated with the text are extracted from a specific webpage. For example, a text and its associated subject word can be extracted from an encyclopedia website, and the subject word serves as a label of this passage of text. Because the encyclopedia website contains a large number of data entries, a large scale of subject words and a wide range of subject words, it is particularly suitable for acting as a training data to train a neural network matching model.

At 704, a matching model with a neural network is trained by using the subject word as a positive label and one or more other subject words (except for the above subject word) as negative labels. For example, the contents collected from the encyclopedia website act as the corpus to train the matching model. During the training, apart from the used positive labels, negative labels irrelevant to the text are also utilized for training, so as to improve accuracy of the matching model.

At 706, a label associated with a sentence is determined using a trained matching model. For example, the matching model can find, through matching, a corresponding label for a given sentence. Compared to the traditional generative label, the matching label, due to a finite set, can improve the speed for obtaining a label.

FIG. 8 illustrates a schematic diagram of a neural network semantic matching model 800 in accordance with embodiments of the present disclosure. As shown in FIG. 8, the neural network semantic matching model 800, from bottom to top, can be mainly divided into input layer 810, representation layer 820 and matching layer 830. The input layer 810 is provided for converting a sentence and a label respectively into a word embedding vector; the representation layer 820 includes a neural network layer having a plurality of hidden layers, such as CNN, RNN and the like; and the matching layer 830 is used for calculating similarity between representation vectors of the sentence and representation vectors of the label. In some embodiments, the two ends to be matched may be converted into semantic representation vectors of equal length as much as possible, and then the matching degree is calculated on the basis of two semantic representation vectors corresponding to the two ends. For example, the matching score may be calculated through a fixed metric function or fitted via a multi-layer sensor network. In this way, the label associated with the sentence can be quickly and efficiently determined due to the use of the neural network semantic matching model.

The method and functionality described herein can be performed, at least in part, by one or more hardware logic components. For example, and without limitation, illustrative types of hardware logic components that can be used include Field-Programmable Gate Arrays (FPGAs), Application-specific Integrated Circuits (ASICs), Application-specific Standard Products (ASSPs), System-on-a-chip systems (SOCs), Complex Programmable Logic Devices (CPLDs), and the like.

Program code for carrying out methods of the present disclosure may be written in any combination of one or more programming languages. These program codes may be provided to a processor or controller of a general purpose computer, special purpose computer, or other programmable data processing apparatus, such that the program codes, when executed by the processor or controller, cause the functions/operations specific in the flowcharts and/or block diagrams to be implemented. The program code may execute entirely on a machine, partly on the machine, as a stand-alone software package, partly on the machine and partly on a remote machine or entirely on the remote machine or server.

In the context of this disclosure, a machine readable medium may be any tangible medium that may contain, or store a program for use by or in connection with an instruction execution system, apparatus, or device. The machine readable medium may be a machine readable signal medium or a machine readable storage medium. A machine readable medium may include but not limited to an electronic, magnetic, optical, electromagnetic, infrared, or semiconductor system, apparatus, or device, or any suitable combination of the foregoing. More specific examples of the machine readable storage medium would include an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a magnetic storage device, or any suitable combination of the foregoing.

Further, although operations are depicted in a particular order, it should be understood that the operations are required to be executed in the shown particular order or in a sequential order, or all shown operations are required to be executed to achieve the expected results. In certain circumstances, multitasking and parallel processing may be advantageous. Likewise, while several specific implementation details are contained in the above discussions, these should not be construed as limitations on the scope of the present disclosure. Certain features that are described in the context of separate implementations may also be implemented in combination in a single implementation. Conversely, various features that are described in the context of a single implementation may also be implemented in multiple implementations separately or in any suitable sub-combination.

Some example implementations of the present disclosure are listed below.

In one aspect, there is provided a computer-implemented method. The method comprises: generating a plurality of sentences based on a target passage; determining labels associated with sentences in the plurality of sentences; obtaining icons corresponding to the labels; and displaying the sentences, the labels and the icons in association in a user interface of an application for presentation.

In some embodiments, wherein the determining labels associated with sentences in the plurality of sentences comprises: extracting, from a specific webpage, a text and a subject word associated with the text; training a matching model with a neural network using the subject word as a positive label and one or more other subject words other than the subject word as negative labels; and determining the labels associated with the sentences using the trained matching model.

In some embodiments, wherein the displaying comprises: determining a template for the user interface; and filling the sentences, the labels and the icons into corresponding parts of the template.

In some embodiments, wherein the displaying comprises: determining a theme associated with the target passage; obtaining an image associated with the theme; and filling the image into the template as a background image of the user interface.

In some embodiments, wherein the generating a plurality of sentences comprises: splitting the target passage into a set of sentences; ranking sentences in the set of sentences; selecting, based on the ranking, a subset of sentences from the set of sentences; and adjusting an order of sentences in the subset of sentences to obtain the plurality of sentences.

In some embodiments, wherein the ranking sentences in the set of sentences comprises: extracting a set of features of each sentence in the set of sentences, wherein the set of features at least comprises a structure feature and a content feature of a sentence, the structural feature at least comprises a position and a length of the sentence, and the content feature at least comprises a degree of overlapping between the sentence and a theme of the target passage and a ratio of stop words in the sentence; and ranking, based on the set of features, sentences in the set of sentences.

In some embodiments, wherein the generating a plurality of sentences comprises: converting a first sentence in the plurality of sentences into a second sentence, wherein a length of the second sentence is shorter than a length of the first sentence.

In some embodiments, wherein the converting a first sentence in the plurality of sentences into a second sentence comprises: converting the first sentence into a first candidate sentence and a second candidate sentence; displaying, at one side of the user interface of the application, the first candidate sentence and the second candidate sentence; and determining the second sentence based on a user selection for the first candidate sentence or the second candidate sentence.

In some embodiments, wherein the converting a first sentence in the plurality of sentences into a second sentence comprises: determining a semantic importance of each word in the first sentence; extracting, from the first sentence, an important word based on the semantic importance; and generating the second sentence using the extracted important word.

In some embodiments, wherein the converting a first sentence in the plurality of sentences into a second sentence comprises: training a sentence conversion model using a pair of long and short sentences, wherein the pair of long and short sentences comprises training samples having long sentences and associated short sentences; and converting the first sentence into the second sentence using the trained sentence conversion model.

In another aspect, there is provided an electronic device. The electronic device comprises a processing unit and a memory coupled to the processing unit and storing instructions. Then instructions, when executed by the processing unit, perform following actions of: generating a plurality of sentences based on a target passage; determining labels associated with sentences in the plurality of sentences; obtaining icons corresponding to the labels; and displaying the sentences, the labels and the icons in association in a user interface of an application for presentation.

In some embodiments, wherein the determining labels associated with sentences in the plurality of sentences comprises: extracting, from a specific webpage, a text and a subject word associated with the text; training a matching model with a neural network using the subject word as a positive label and one or more other subject words other than the subject word as negative labels; and determining the labels associated with the sentences using the trained matching model.

In some embodiments, wherein the displaying comprises: determining a template for the user interface; and filling the sentences, the labels and the icons into corresponding parts of the template.

In some embodiments, wherein the displaying comprises: determining a theme associated with the target passage; obtaining an image associated with the theme; and filling the image into the template as a background image of the user interface.

In some embodiments, wherein the generating a plurality of sentences comprises: splitting the target passage into a set of sentences; ranking sentences in the set of sentences; selecting, based on the ranking, a subset of sentences from the set of sentences; and adjusting an order of sentences in the subset of sentences to obtain the plurality of sentences.

In some embodiments, wherein the ranking sentences in the set of sentences comprises: extracting a set of features of each sentence in the set of sentences, wherein the set of features at least comprises a structure feature and a content feature of a sentence, the structural feature at least comprises a position and a length of the sentence, and the content feature at least comprises a degree of overlapping between the sentence and a theme of the target passage and a ratio of stop words in the sentence; and ranking, based on the set of features, sentences in the set of sentences.

In some embodiments, wherein the generating a plurality of sentences comprises: converting a first sentence in the plurality of sentences into a second sentence, wherein a length of the second sentence is shorter than a length of the first sentence.

In some embodiments, wherein the converting a first sentence in the plurality of sentences into a second sentence comprises: converting the first sentence into a first candidate sentence and a second candidate sentence; displaying, at one side of the user interface of the application, the first candidate sentence and the second candidate sentence; and determining the second sentence based on a user selection for the first candidate sentence or the second candidate sentence.

In some embodiments, wherein the converting a first sentence in the plurality of sentences into a second sentence comprises: determining a semantic importance of each word in the first sentence; extracting, from the first sentence, an important word based on the semantic importance; and generating the second sentence using the extracted important word.

In some embodiments, wherein converting a first sentence in the plurality of sentences into a second sentence comprises: training a sentence conversion model using a pair of long and short sentences, wherein the a pair of long and short sentences includes training samples having long sentences and associated short sentences; and converting the first sentence into the second sentence using a trained sentence conversion model.

In a further aspect, there is provided a computer program product. The computer program product is stored on a storage medium and includes machine-executable instructions. The machine-executable instructions, when executed in a device, cause the device to: generate a plurality of sentences based on a target passage; determine labels associated with sentences in the plurality of sentences; obtain icons corresponding to the labels; and display the sentences, the labels and the icons in association in a user interface of an application for presentation.

In some embodiments, wherein the determining labels associated with sentences in the plurality of sentences comprises: extracting, from a specific webpage, a text and a subject word associated with the text; training a matching model with a neural network using the subject word as a positive label and one or more other subject words other than the subject word as negative labels; and determining the labels associated with the sentences using the trained matching model.

In some embodiments, wherein the displaying comprises: determining a template for the user interface; and filling the sentences, the labels and the icons into corresponding parts of the template.

In some embodiments, wherein the displaying comprises: determining a theme associated with the target passage; obtaining an image associated with the theme; and filling the image into the template as a background image of the user interface.

In some embodiments, wherein the generating a plurality of sentences comprises: splitting the target passage into a set of sentences; ranking sentences in the set of sentences; selecting, based on the ranking, a subset of sentences from the set of sentences; and adjusting an order of sentences in the subset of sentences to obtain the plurality of sentences.

In some embodiments, wherein the ranking sentences in the set of sentences comprises: extracting a set of features of each sentence in the set of sentences, wherein the set of features at least comprises a structure feature and a content feature of a sentence, the structural feature at least comprises a position and a length of the sentence, and the content feature at least comprises a degree of overlapping between the sentence and a theme of the target passage and a ratio of stop words in the sentence; and ranking, based on the set of features, sentences in the set of sentences.

In some embodiments, wherein the generating a plurality of sentences comprises converting a first sentence in the plurality of sentences into a second sentence, wherein a length of the second sentence is shorter than a length of the first sentence.

In some embodiments, wherein the converting a first sentence in the plurality of sentences into a second sentence comprises: converting the first sentence into a first candidate sentence and a second candidate sentence; displaying, at one side of the user interface of the application, the first candidate sentence and the second candidate sentence; and determining the second sentence based on a user selection for the first candidate sentence or the second candidate sentence.

In some embodiments, wherein the converting a first sentence in the plurality of sentences into a second sentence comprises: determining a semantic importance of each word in the first sentence; extracting, from the first sentence, an important word based on the semantic importance; and generating the second sentence using the extracted important word.

In some embodiments, wherein converting a first sentence in the plurality of sentences into a second sentence comprises: training a sentence conversion model using a pair of long and short sentences, wherein the a pair of long and short sentences includes training samples having long sentences and associated short sentences; and converting the first sentence into the second sentence using a trained sentence conversion model.

Although the subject matter has been described in language specific to structural features and/or methodological acts, it is to be understood that the subject matter specific in the appended claims is not necessarily limited to the specific features or acts described above. Rather, the specific features and acts described above are disclosed as example forms of implementing the claims.

1. A computer-implemented method, comprising:
generating a plurality of sentences based on a target passage;
determining labels associated with sentences in the plurality of sentences;
obtaining icons corresponding to the labels; and
displaying the sentences, the labels and the icons in association in a user interface of an application for presentation.

2. The method of claim 1, wherein the determining labels associated with sentences in the plurality of sentences comprises:
extracting, from a specific webpage, a text and a subject word associated with the text;
training a matching model with a neural network using the subject word as a positive label and one or more other subject words other than the subject word as negative labels; and
determining the labels associated with the sentences using the trained matching model.

3. The method of claim 1, wherein the displaying comprises:
determining a template for the user interface; and
filling the sentences, the labels and the icons into corresponding parts of the template.

4. The method of claim 3, wherein the displaying comprises:
determining a theme associated with the target passage;
obtaining an image associated with the theme; and
filling the image into the template as a background image of the user interface.

5. The method of claim 1, wherein the generating a plurality of sentences comprises:
splitting the target passage into a set of sentences;
ranking sentences in the set of sentences;
selecting, based on the ranking, a subset of sentences from the set of sentences; and
adjusting an order of sentences in the subset of sentences to obtain the plurality of sentences.

6. The method of claim 5, wherein the ranking sentences in the set of sentences comprises:
extracting a set of features of each sentence in the set of sentences, the set of features at least comprising a structure feature and a content feature of a sentence, the structural feature at least comprising a position and a length of the sentence, and the content feature at least comprising a degree of overlapping between the sentence and a theme of the target passage and a ratio of stop words in the sentence; and
ranking, based on the set of features, sentences in the set of sentences.

7. The method of claim 1, wherein the generating a plurality of sentences comprises:
converting a first sentence in the plurality of sentences into a second sentence, a length of the second sentence being shorter than a length of the first sentence.

8. The method of claim 7, wherein the converting a first sentence in the plurality of sentences into a second sentence comprises:
converting the first sentence into a first candidate sentence and a second candidate sentence;
displaying, at one side of the user interface of the application, the first candidate sentence and the second candidate sentence; and
determining the second sentence based on a user selection for the first candidate sentence or the second candidate sentence.

9. The method of claim 7, wherein the converting a first sentence in the plurality of sentences into a second sentence comprises:
determining a semantic importance of each word in the first sentence;
extracting, from the first sentence, an important word based on the semantic importance; and
generating the second sentence using the extracted important word.

10. The method of claim 7, wherein the converting a first sentence in the plurality of sentences into a second sentence comprises:
training a sentence conversion model using a pair of long and short sentences, the pair of long and short sentences comprising training samples having long sentences and associated short sentences; and
converting the first sentence into the second sentence using the trained sentence conversion model.

11. An electronic device, comprising:
a processing unit; and
a memory coupled to the processing unit and storing instructions, the instructions, when executed by the processing unit, perform following actions of:
generating a plurality of sentences based on a target passage;
determining labels associated with sentences in the plurality of sentences;
obtaining icons corresponding to the labels; and
displaying the sentences, the labels and the icons in association in a user interface of an application for presentation.

12. The device of claim 11, wherein the determining labels associated with sentences in the plurality of sentences comprises:
extracting, from a specific webpage, a text and a subject word associated with the text;
training a matching model with a neural network using the subject word as a positive label and one or more other subject words other than the subject word as negative labels; and
determining the labels associated with the sentences using the trained matching model.

13. The device of claim 11, wherein the displaying comprises:
determining a template for the user interface; and
filling the sentences, the labels and the icons into corresponding parts of the template.

14. The device of claim 13, wherein the displaying comprises:
determining a theme associated with the target passage;
obtaining an image associated with the theme; and
filling the image into the template as a background image of the user interface.

15. A computer program product stored on a storage medium and comprising machine-executable instructions, the machine-executable instructions, when executed in a device, causing the device to:
generate a plurality of sentences based on a target passage;
determine labels associated with sentences in the plurality of sentences;
obtain icons corresponding to the labels; and
display the sentences, the labels and the icons in association in a user interface of an application for presentation.
